(19) United States
(12) Patent Application Publication
(10) Pub. No.: US 2018/0288052 A1
(43) Pub. Date: Oct. 4, 2018

(54) TRUSTED REMOTE CONFIGURATION AND OPERATION

(71) Applicant: McAfee, Inc., Santa Clara, CA (US)

(72) Inventors: VENKATA RAMANAN SAMBANDAM, SANTA CLARA, CA (US); CARL D. WOODWARD, CAMPBELL, CA (US); DMITRI RUBAKHA, SANTA CLARA, CA (US)

(21) Appl. No.: 15/476,542

(22) Filed: Mar. 31, 2017

(51) Int. Cl. H04L 29/06; H04L 9/08

(52) U.S. Cl. CPC H04L 63/10; H04L 9/0822; H04L 63/0428

(57) ABSTRACT

Techniques related to trusted remote configuration and operation using multiple devices are disclosed. The techniques include a machine-readable medium, on which are stored instructions, comprising instructions that when executed cause a target device to receive, from a connecting device, a capabilities request, measure, in response to the capabilities request, the trusted capabilities of the target device, generate a list of trusted capabilities, transmit, to the connecting device, the list of trusted capabilities, receive, from the connecting device, an access request for a trusted capability, the access request describing a workload for the trusted capability, perform the workload to obtain a result, and transmit, to the connecting device, the obtained result.

### TECHNICAL FIELD

Embodiments described herein generally relate to the field of computer security and, more particularly, to methods and systems related to trusted remote configuration and operation using multiple devices.

### BACKGROUND ART

Devices are becoming available in a variety of non-traditional form factors, such as wearable devices and remote sensing devices. These devices may make certain capability trade-offs to enable better performance of certain tasks of physically fit in certain environments. For example, a wearable device may be limited to a relatively small screen size to allow the device to be worn. Similarly, another device, such as a sensor device, may be a headless device and not include a screen at all to fit power and/or size constraints.

These devices may be capable of connecting to other devices to extend their capabilities, such as an external screen or other interface. Previously, these connections between devices generally served to perform specific tasks and required specific programming. For example, a mobile device may utilize a specific interface to connect to a screen in a car and another, separate interface for connecting to a TV, rather than a generic or common interface.

In establishing these connections between devices, a connection request between a connecting device and a target device may be authorized by a user via, for example, a confirmation check in the user interface (UI) or by entering a personal identification number (PIN). However, while authorizing a connection may provide an indication that a particular connection is intended, this authorization may not provide any indication that the connection may be trusted. An authorized connection may be susceptible to, for example, man-in-the-middle replay attacks, unauthorized or modified code utilizing the connection, or other attack vectors. Consequently, there is a need for a generic interface capable of adapting to capabilities offered by various devices and connecting to the various devices in a trusted manner.

### BRIEF DESCRIPTION OF DRAWINGS

FIG. 1 is a block diagram illustrating a programmable device, according to one embodiment.

FIG. 2 is a block diagram illustrating a programmable device, according to one embodiment.

FIG. 3 is a block diagram illustrating a security component, according to an embodiment.

FIG. 4 is a block diagram illustrating a security component, according to an embodiment.

FIG. 5 is a block diagram illustrating a remote trusted execution system, according to one embodiment.

FIG. 6 is a flowchart illustrating a technique for establishing a trusted remote connection, according to one embodiment.

FIG. 7 is a flowchart illustrating a technique for establishing a trusted remote connection, according to one embodiment.

### DESCRIPTION OF EMBODIMENTS

As indicated above, there are physical limitations innate to certain device form factors which may limit the ways in which a user may interact with the device. These limitations may include size, shape, weight, available power, location, and other such limitations. For example, a sensor device may need to be very compact and power efficient to allow the remote sensor to be placed in difficult to reach areas. As a result, the sensor device may have limited on-board computing resources and possibly no on-board user interface at all. Rather, the sensor device may rely on a connection with a remote surface to enable remote configuration and operation of the sensor device. Where the sensor device does include a user interface, allowing the sensor device to connect to the remote surface to enable a more convenient and/or user friendly interface may be desirable.

Existing systems such as Apple iCloud allow authentication and addition of devices to an account in order to synchronize account information. However, such systems generally do not allow for a device to connect to another device to extend the operations of the other device, but rather authenticate and push information.

Other systems, such as accessing a kernel-based virtual machine via transport layer security function to allow the establishment of a secure connection to a virtualized computer system to enable a user to access the virtualized computer system, but also do not allow for one device to extend the operations of another device.

Certain other devices may be vPro-compatible, where vPro is available on devices from Intel Corporation of Santa Clara, Calif., and utilize a public-key based authentication of the other devices. Such systems facilitate establishing trusted connections between devices, but also do not directly address extending operations for the other device.

Although some processor functionality, such as Intel's Software Guard Extensions (SGX) functionality, allows for trusted I/O between the processor and an I/O device, these processor-based capabilities do not allow for one device to extend the operations of another device.

This ability of devices to connect to a remote surface may present an opportunity for malicious software or actors to disrupt or stop device operations, steal information, gain unauthorized access to system resources, and conduct other unauthorized activities. For example, malware authors may attempt to compromise a device by attempting to modify software on an Internet connected remote surface to perform a man-in-the-middle attack. As another example, an unauthorized user may attempt to connect to a device directly in order to maliciously disable or use the device as a part of a botnet. Consequently, there is a need for effective methods for enabling remote configurations and operations using trusted components.

As used herein, trust generally refers to an expectation that a device will behave in a particular manner for a specific purpose. In establishing a trust relationship, trusted components are able to vouch, or attest, for their own integrity by collecting and providing evidence that the component has not been tampered with. For example, a component may be measured to generate an indication associated with the component such that any change to the component produces a change in the indication. In one example, a cryptographic hash value of the component may be made, the cryptographic hash having strong collisions resistance such that any changes to the component results in a different hash value. This resulting hash value may be compared to an expected value, to detect any changes to the component. An indication of the integrity of the component may then be passed on attesting that the component has not been tampered with in establishing the trust relationship. Additionally, other techniques for attestation may be used and other types of measurement techniques may also be used as desired.

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “a programmable device” can refer to a single programmable device or a plurality of programmable devices working together to perform the function described as being performed on or by the programmable device. Similarly, “a machine-readable medium” can refer to a single physical medium or a plurality of media that together may store the material described as being stored on the machine-readable medium.

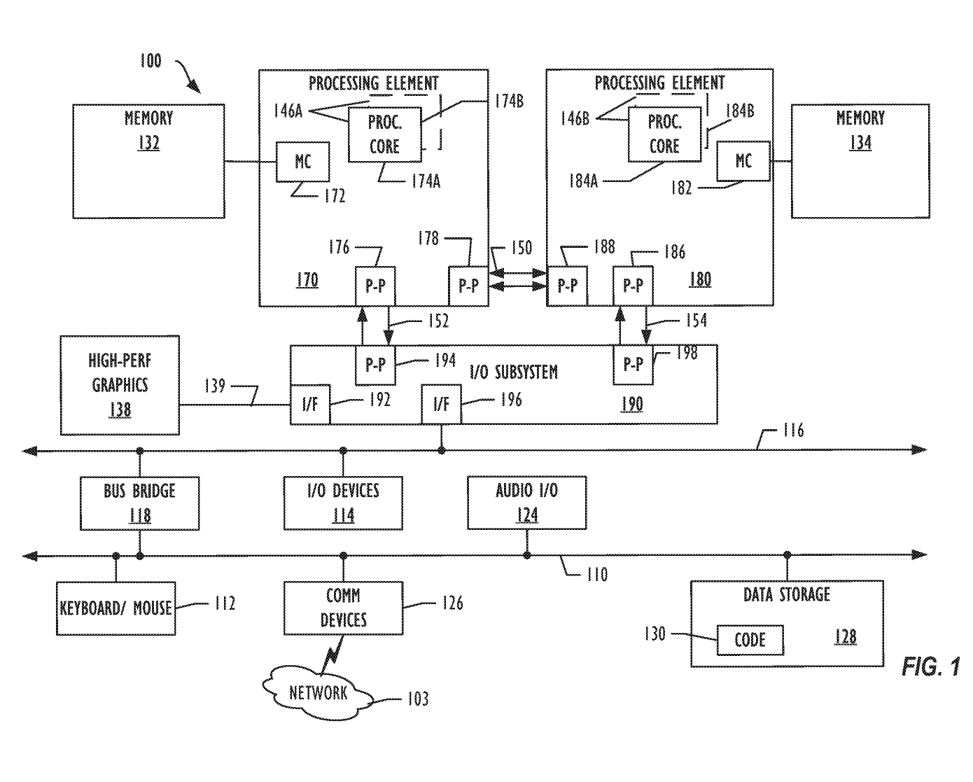

Referring now to FIG. 1, a block diagram illustrates a programmable device 100 that may be used for implementing the techniques described herein in accordance with one embodiment. The programmable device 100 illustrated in FIG. 1 is a multiprocessor programmable device that includes a first processing element 170 and a second processing element 180. While two processing elements 170 and 180 are shown, an embodiment of programmable device 100 may also include only one such processing element.

Programmable device 100 is illustrated as a point-to-point interconnect system, in which the first processing element 170 and second processing element 180 are coupled via a point-to-point interconnect 150. Any or all of the interconnects illustrated in FIG. 1 may be implemented as a multi-drop bus rather than point-to-point interconnects.

As illustrated in FIG. 1, each of processing elements 170 and 180 may be multicore processors, including first and second processor cores (i.e., processor cores 174a and 174b and processor cores 184a and 184b). Such cores 174a, 174b, 184a, 184b may be configured to execute instruction code. However, other embodiments may use processing elements that are single core processors as desired. In embodiments with multiple processing elements 170, 180, each processing element may be implemented with different numbers of cores as desired.

Each processing element 170, 180 may include at least one shared cache 146. The shared cache 146a, 146b may store data (e.g., instructions) that are utilized by one or more components of the processing element, such as the cores 174a, 174b and 184a, 184b, respectively. For example, the shared cache may locally cache data stored in a memory 132, 134 for faster access by components of the processing elements 170, 180. In one or more embodiments, the shared cache 146a, 146b may include one or more mid-level caches, such as level 2 (L2), level 3 (L3), level 4 (L4), or other levels of cache, a last level cache (LLC), or combinations thereof.

While FIG. 1 illustrates a programmable device with two processing elements 170, 180 for clarity of the drawing, the scope of the present invention is not so limited and any number of processing elements may be present. Alternatively, one or more of processing elements 170, 180 may be an element other than a processor, such as an graphics processing unit (GPU), a digital signal processing (DSP) unit, a field programmable gate array, or any other programmable processing element. Processing element 180 may be heterogeneous or asymmetric to processing element 170. There may be a variety of differences between processing elements 170, 180 in terms of a spectrum of metrics of merit including architectural, microarchitectural, thermal, power consumption characteristics, and the like. These differences may effectively manifest themselves as asymmetry and heterogeneity amongst processing elements 170, 180. In some embodiments, the various processing elements 170, 180 may reside in the same die package.

First processing element 170 may further include memory controller logic (MC) 172 and point-to-point (P-P) interconnects 176 and 178. Similarly, second processing element 180 may include a MC 182 and P-P interconnects 186 and 188. As illustrated in FIG. 1, MCs 172 and 182 couple processing elements 170, 180 to respective memories, namely a memory 132 and a memory 134, which may be portions of main memory locally attached to the respective processors. While MC logic 172 and 182 is illustrated as integrated into processing elements 170, 180, in some embodiments the memory controller logic may be discrete logic outside processing elements 170, 180 rather than integrated therein.

Processing element 170 and processing element 180 may be coupled to an I/O subsystem 190 via respective P-P interconnects 176 and 186 through links 152 and 154. As illustrated in FIG. 1, I/O subsystem 190 includes P-P interconnects 194 and 198. Furthermore, I/O subsystem 190 includes an interface 192 to couple I/O subsystem 190 with a high performance graphics engine 138. In one embodiment, a bus (not shown) may be used to couple graphics engine 138 to I/O subsystem 190. Alternately, a point-to-point interconnect 139 may couple these components.

In turn, I/O subsystem 190 may be coupled to a first link 116 via an interface 196. In one embodiment, first link 116 may be a Peripheral Component Interconnect (PCI) bus, or a bus such as a PCI Express bus or another I/O interconnect bus, although the scope of the present invention is not so limited.

As illustrated in FIG. 1, various I/O devices 114, 124 may be coupled to first link 116, along with a bridge 118 that may couple first link 116 to a second link 110. In one embodiment, second link 120 may be a low pin count (LPC) bus. Various devices may be coupled to second link 120 including, for example, a keyboard/mouse 112, communication device(s) 126 (which may in turn be in communication with the computer network 103), and a data storage unit 128 such as a disk drive or other mass storage device which may include code 130, in one embodiment. The code 130 may include instructions for performing embodiments of one or more of the techniques described above. Further, an audio I/O 124 may be coupled to second link 120.

Note that other embodiments are contemplated. For example, instead of the point-to-point architecture of FIG. 1, a system may implement a multi-drop bus or another such communication topology. Although links 116 and 120 are illustrated as busses in FIG. 1, any desired type of link may be used. In addition, the elements of FIG. 1 may alternatively be partitioned using more or fewer integrated chips than illustrated in FIG. 1.

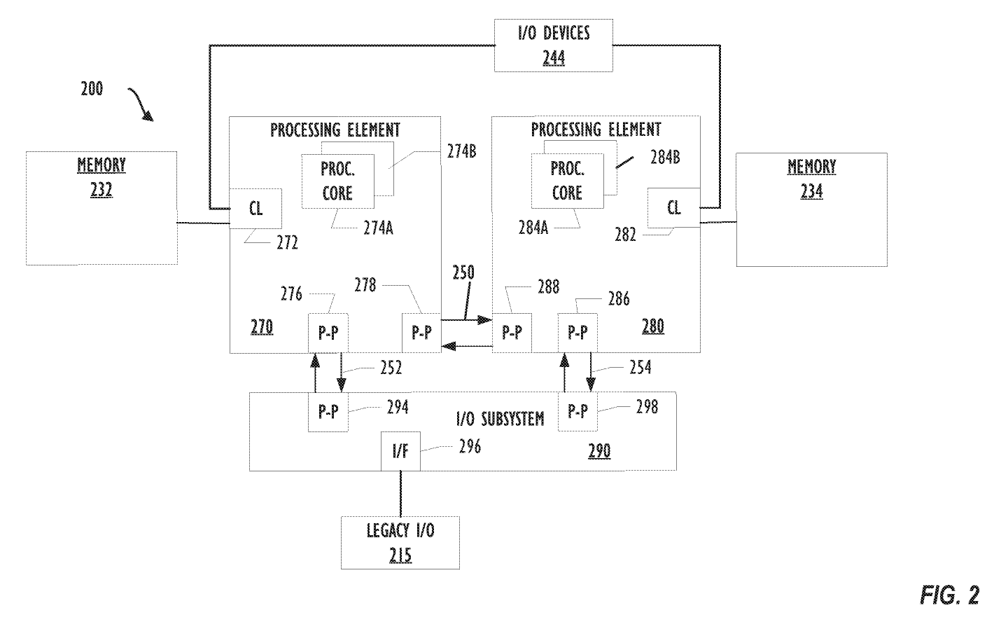

Referring now to FIG. 2, a block diagram illustrates a programmable device 200 according to another embodiment. Certain aspects of FIG. 2 have been omitted from FIG. 2 in order to avoid obscuring other aspects of FIG. 2.

FIG. 2 illustrates that processing elements 270, 280 may include integrated memory and I/O control logic (“CL”) 272 and 282, respectively. In some embodiments, the 272, 282 may include memory control logic (MC) such as that described above in connection with FIG. 1. In addition, CL 272, 282 may also include I/O control logic. FIG. 2 illustrates that not only may the memories 232, 234 be coupled to the CL 272, 282, but also that I/O devices 244 may also be coupled to the control logic 272, 282. Legacy I/O devices 215 may be coupled to the I/O subsystem 290 by interface 296. Each processing element 270, 280 may include multiple processor cores, illustrated in FIG. 2 as processor cores 274A, 274B, 284A and 284B. As illustrated in FIG. 2, I/O subsystem 290 includes point-to-point (P-P) interconnects 294 and 298 that connect to P-P interconnects 276 and 286 of the processing elements 270 and 280 with links 252 and 254. Processing elements 270 and 280 may also be interconnected by link 250 and interconnects 278 and 288, respectively.

The programmable devices depicted in FIGS. 1 and 2 are schematic illustrations of embodiments of programmable devices that may be utilized to implement various embodiments discussed herein. Various components of the programmable devices depicted in FIGS. 1 and 2 may be combined in a system-on-a-chip (SoC) architecture.

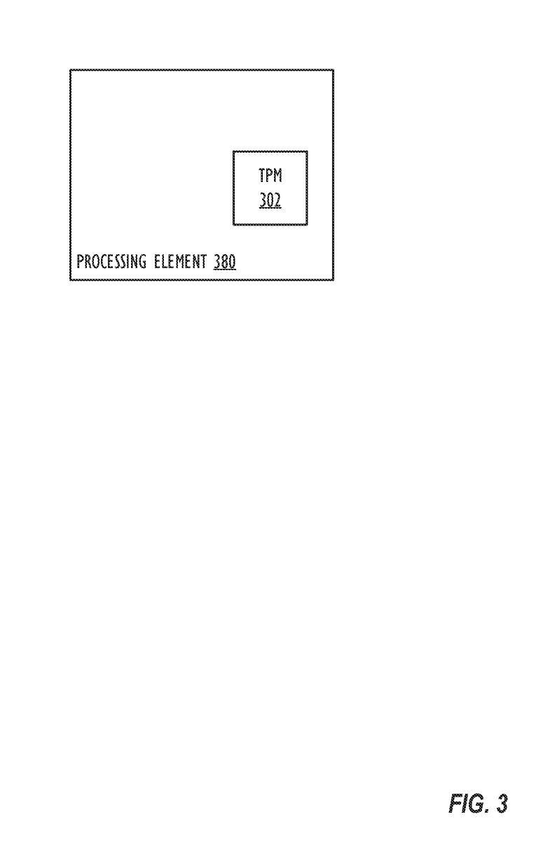

A remote trusted execution system generally includes a security component to establish trust relationships. An example of such a security component includes a trusted platform module (TPM). A TPM is a hardware component that resides within a processing system and provides various facilities and services for enhancing the security of the processing system. For example, a TPM may be implemented as an integrated circuit (IC) or semiconductor chip, or as a part of an integrated circuit. In certain cases, a TPM may be communicatively coupled to a processing element, such as processing elements 270 and 280 via links, such as links 252 and 254. In other cases, as shown in FIG. 3, a TPM 302 may be integrated within a processing element 380, for example as a part of a SoC architecture.

The TPM may be used to protect data and to attest to the runtime configuration of a platform. A TPM may be implemented in accordance with specifications such as the Trusted Computing Group (TCG) TPM Specification Version 1.2, dated Oct. 2, 2003 (hereinafter the “TPM specification”), which includes parts such as Design Principles, Structures of the TPM, and TPM Commands. The TPM specification is published by the TCG and is currently available from the Internet at www.trustedcomputinggroup.org.

A TCG-compliant TPM provides security services such as attesting to the identity and/or integrity of the platform, based on characteristics of the platform. For instance, trusted computing technologies may provide facilities for measuring, recording, and reporting the software configuration of a platform. For instance, the measurements may include load-time measurements of software to generate a value associated with the software such that any change in the software produces a change in the generated value in order to detect any changes to the software. The TPM may include protected storage for private encryption keys, certificates, and/or signatures which provide a root of trust for other components.

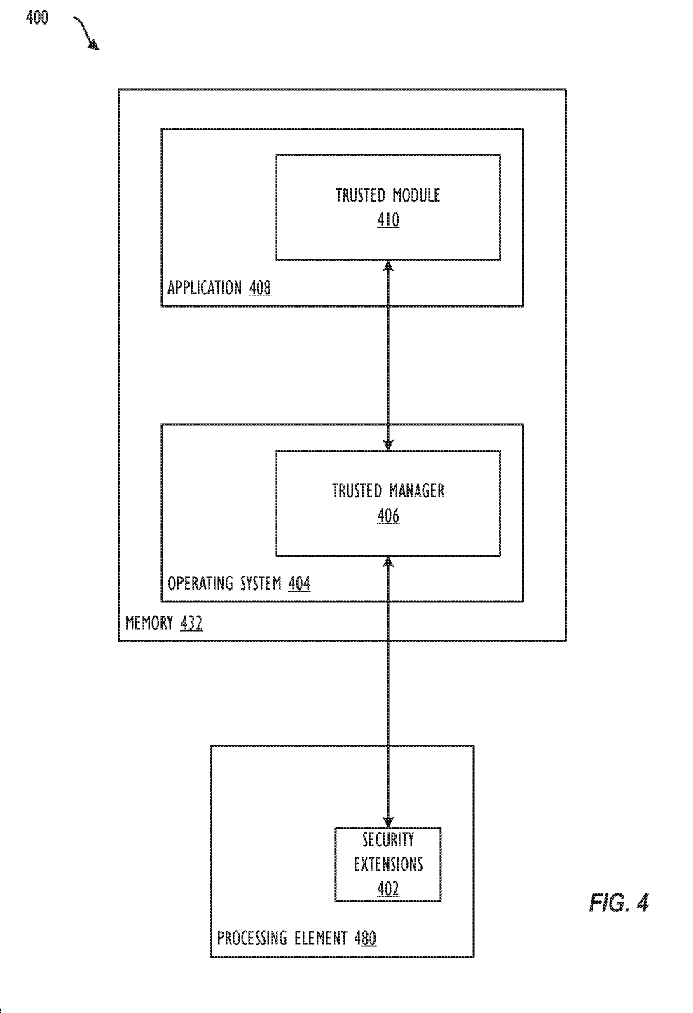

Another example of a security component includes software extensions as illustrated in FIG. 4. FIG. 4 is a block diagram illustrating software extensions in a remote trusted execution system 400, in accordance with aspects of the present disclosure. The remote trusted execution system 400 may include a processing element 480 including security extensions 402. For example, a host computer system may provide secure execution environment functionality via the Intel® Software Guard Extensions (referred to herein as “Intel® SGX” or more simply as “SGX”) that may be enabled on the processing core of the host computer system. The security extensions 402 may be utilized by an operating system 404 via a trusted manager 406 or by an application 408 via a trusted module 410 executing in memory 432. The security extensions 402 may enable user-level code to allocate private regions of memory (secure enclaves) protected from processes running at other privilege levels, including those processes running at higher privilege levels. SGX may also include hardware, such as registers, or instructions for attestation of the secure enclave, executing processes, and performing certain file input and output operations from the secure enclave. Additionally, trust relationships may be established with any other security components presently known.

Generally, the security components, among other features, enable establishing trust relationships by attesting to the authenticity of components of the computing system by measuring the software and hardware components via, for example, by performing a cryptographic hash on the software, firmware, loader or other component. Measurements may be made of code, data structures, configuration, information, or anything that can be loaded into memory and measurements are performed such that if the component being measured has been altered or changed, the results of the measurement would be different. In some cases, user authentication may also be performed during the attestation process, for example, using passwords, biometrics, two-factor authentication, or other known user authentication techniques.

Attestation of the software and hardware components may also be communicated to a third party, allowing that third party to verify that the software and hardware components of the computing system have not been changed. In some cases, third parties may be separate and remote from the computing system and remote attestation via, for example another trusted third party or direct anonymous attestation, may be used to enable establishing the trust relationship.

After attestation, attested software may be executed in or obtain services from a trusted execution environment (TEE), such as provided by a TPM or a secure enclave. In executing code via the TEE, the device may operate in a protected mode, allowing the code executing in the TEE to operate in a trusted environment isolated from other code executing on the device.

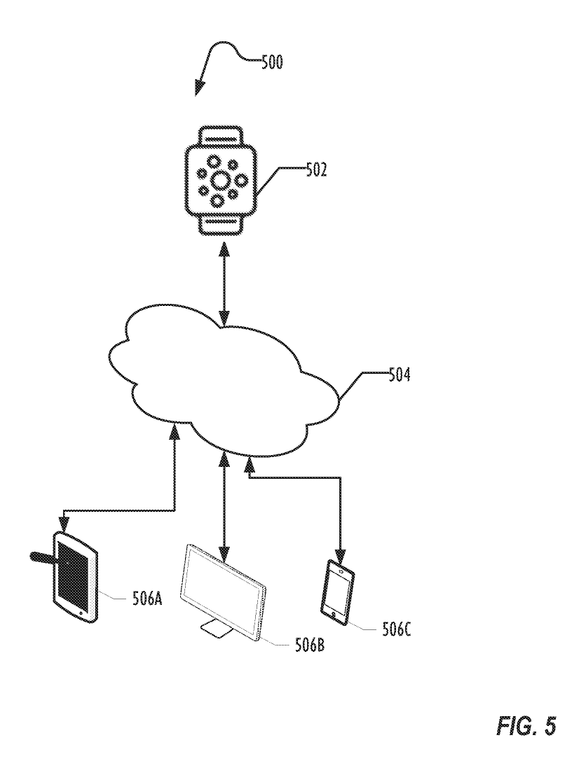

Referring now to FIG. 5, a block diagram illustrates a remote trusted execution system 500 in accordance with an embodiment. FIG. 5 illustrates that the remote trusted execution system 500 may include a trusted device 502, communications linkage 504, and remote surfaces 506A, 506B and 506C. A trusted device may be any device capable of establishing a trusted connection with another device. Non-limiting examples of a trusted device may include smartwatches, smartphones, appliances, or sensor nodes. A remote surface may be any device capable of establishing a trusted connection. The remote surface may also be able to enable capabilities not present in the trusted device. Non-limiting examples of remote surfaces may include personal computers, smartphones, tablets, smart TVs, automotive electronics, or processing nodes. Of note, a particular device may be a trusted device in one usage case and a remote surface in another usage case. In some cases, trusted devices may function as both a trusted device and a remote surface at once, for example, when daisy chained between another trusted device and another remote surface.

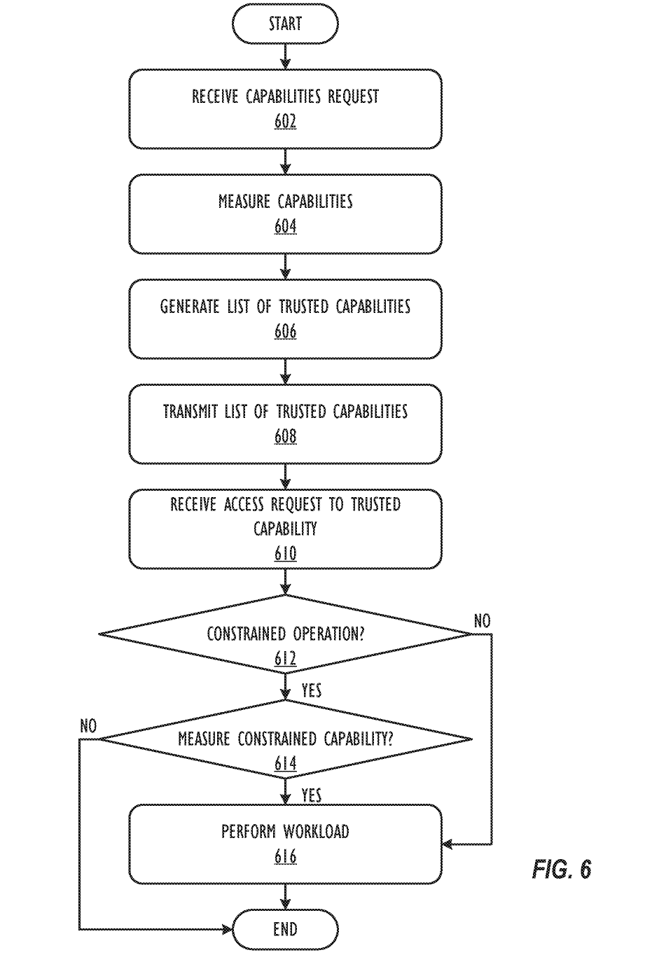

FIG. 6 is a flowchart illustrating a technique for establishing a trusted remote connection, in accordance with aspects of the present disclosure. In block 602, a remote surface, such as one of remote surfaces 506A, 506B and 506C, receives a capabilities request from a trusted device, such as trusted device 502, after a low level connection is established between the remote surface and the trusted device. As used herein, the low level connection may generally refer to establishing a connection between two or more devices sufficient to enable the devices to exchange datagrams and may be established over any known physical medium, including, but not limited to wireless and wired connections.

In accordance with certain aspects of the present disclosure, a capabilities request may comprise a remote attestation request as a part of a remote attestation protocol, such as a public key certificate and hash value of the connecting trusted device for use by the remote surface to verify that the connecting trusted device can be trusted. The capabilities request may also include an indication for the remote surface to send capabilities information to the trusted device. The capabilities request may also provide an indication of a minimum set of capabilities required of the remote surface. Where the remote surface does not support the minimum set of capabilities, the remote surface may return an indication that the remote surface does not meet the minimum set of capabilities. In some embodiments, a capability negotiation may occur where the remote surface and trusted device exchange capability information and decide on which features to use.

In block 604, the remote surface makes measurements of software and hardware of the remote surface. These measurements may be made as a part of a remote attestation protocol and may be made prior to establishing any connection. For example, measurements of a device may be performed on boot of the remote surface and stored for later use. Results of the measurements may be communicated to the trusted device as a part of a remote attestation protocol. The trusted device may also provide measurement results as a part of the remote attestation protocol. This remote attestation protocol, as discussed above, cryptographically verifies and ensures that the capabilities indicated as trusted are working as intended with a known good configuration. After the measurements are communicated and verified, a trust relationship between the devices may be established. A secure, trusted communications channel may also be established between the remote surface and trusted device via, for example, an exchanged key as a part of the remote attestation protocol. This communications channel may then be used for further communications between the devices, in accordance with aspects of the present disclosure.

In block 606, a list of trusted capabilities of the remote surface is generated. This list of trusted capabilities may include the capabilities the remote surface may execute within a TEE and be based on the components that are measured. The list of capabilities may be provided in a data structure or markup language along with other properties or metadata relating to the remote surface as shown in Table 1. The format of Table 1 is illustrative and by way of example only, and any desired way of identifying the capabilities may be used. Although referred to as a list, the capabilities may be provided or stored using any type of organization.

TABLE 1
Trusted Capabilities

{

‘device-name’: ‘SURFACE’,
‘ capabilities’:{

CAMERA,
TOUCH_INPUT
PEN_INPUT
SGX

}

}

This list may also be based on a pre-generated list of capabilities, instead of a measurement performed at the time of the request. For example, a device may include a list of capabilities on which measurements may be made and this list may be used, after successful measurements of the capabilities, as the list of trusted capabilities. According to aspects of the present disclosure, capabilities for inclusion in the list of capabilities may be predefined. For example, a TOUCH_INPUT capability may be defined, for example in a standard or specification, to indicate that a device supports touch input of some kind.

In block 608, the list of trusted capabilities is transmitted by the remote surface to the trusted device. This transmission may occur, for example, via a communications channel established after remote attestation, or the previously established trusted communications channel. This transmission may be encrypted, for example, using a key exchanged during remote attestation or generated after remote attestation. The key may be cryptographically secured, for example, via public-private key encryption.

In block 610, the remote surface receives, from the trusted device, an access request to one or more trusted capabilities from the list of trusted capabilities. The access request may include information related to capabilities that the trusted device is attempting to access. According to aspects of the present disclosure, this information may be described in metadata fields. An example access request may be found in Table 2. The format of the request in Table 2 is illustrative and by way of example only, and any desired format may be used.

TABLE 2
Access Request

{

‘device-name’: ‘Smart Watch’,
‘workload’:{<binaryblobofworkload>}
‘controls’:{

‘TOUCHPAD’,
‘PEN_INPUT’,
‘PHY_KEYBOARD’

}
‘acceptable-range’:‘[a-zA-Z0-9_]*’,
‘security-constraint’:{‘

re-attestaion-needed’:{

‘MODIFY_DISPLAY_PROPERTIES’,
‘ABORT_WORKLOAD’,
‘REBOOT’

}
‘trusted-io-required’:{

‘LOGIN’,
‘CAMERA’

}

}

}

The access request may specify a workload for execution by the remote surface. The workload may include data, algorithms, rendering logic, user input handlers, or any other code for execution by the remote surface. For example, the trusted device may include rendering logic along with configuration logic in the workload. The rendering logic may be used to render a UI which accesses the configuration logic to enable the remote surface to be used to configure the trusted device. Inputs from the UI may be used to select among configuration options or enforce valid configurations. The trusted device, as another example, may have limited processing power and may utilize the remote surface to render interactive graphs or charts, calculations, or other processing. Information passed in the workload metadata object, for example, may be compiled code, intermediate code, or any binary large object (i.e., blob). In some embodiments, instead of including the workload in the access request, the access request may contain information about where the remote surface may obtain the workload.

The workload may also include information related to rendering various content and controls on the remote surface. In some cases, this information may be used by the remote surface to directly render to an output device such as a display screen. In other cases, the remote surface may receive data describing content and controls and the remote device may render the output in whatever way makes sense for the form factor of the remote screen. For example, the information may include a list of options from which a user may select. One remote surface may render this list of options as a drop-down menu from which the user may select a menu entry. Another remote surface, such as virtual reality glasses, may render each option from the list as floating text or orbs to which the user may point.

The access request may also include a metadata field related to the controls to be used. The controls metadata may include a list of controls from which the remote surface may accept input from when executing the workload. For example, the trusted device may indicate that the remote surface may only accept input from a physical keyboard and not from an on-screen keyboard.

In some cases an acceptable ranges metadata field may be included in the access request. Acceptable ranges may be defined to limit the range of input the remote surface may accept from the user for a particular control. For example, input from a keyboard may be limited to alphanumeric characters and a limited set of special characters, such as “_[ ]*”.

A security constraint metadata field may also be included in the access request. The security constraints may indicate sensitive operations that require extra scrutiny. In certain cases, the extra scrutiny requires that certain operations be performed using trusted input/output (I/O) to ensure a secure path for input/output operations such as accessing an I/O device such as a camera or performing a login. In some embodiments, where a trusted connection is established without using trusted I/O and a request to use device that is constrained to use trusted I/O is received, re-attestation may be performed for at least the I/O device and components may be configured to use trusted I/O with the I/O device. After successful re-attestation the device may be enabled for use.

In certain cases, this extra scrutiny may include re-attestation of the capabilities required to perform the sensitive operations or even re-attestation of the remote surface. Sensitive operations may include any operations that a user may be restricted from performing. For example, it may be desirable to prevent a user from using a remote surface to reboot the trusted device, but still allow a user to view up-time information from the remote surface. In such cases, rebooting may be listed as a sensitive operation, while viewing up-time is not.

In block 616, the remote surface runs the workload in a TEE enforcing security constraints listed in the access request. Where the remote surface does not request a constrained operation, the remote surface may run the workload associated with the operation in the TEE in block 616 or in some embodiments may run the workload outside the TEE. Controls other than those listed in the access request may be disabled and the remote surface may check control inputs for acceptable ranges and values based on the acceptable ranges metadata. After completing a particular workload, the remote surface may send actions and results from the workload to the trusted device for validation and acting upon the actions and results. For example, where the workload is associated with a configuration option where the user may select an option from a list of options, the option ultimately selected by the user may be communicated to the trusted device as a result. The trusted device may then act upon the result by implementing the selected option. In some embodiments, the result of the workload may include instructions for the trusted device to perform.

Where the remote surface requests a constrained operation in block 612, the remote surface may perform a re-attestation and in block 614, measures a capabilities associated with the constrained operation. The trusted device may also perform re-attestation and provide the remote surface with measurement results. Re-attestation may include verifying the identity of the user of the remote surface and verifying that the user is authorized to access sensitive operations on either the trusted device, remote surface, or both. After successful re-attestation, the remote surface runs the workload associated with the constrained operation in block 616 and after completing the workload, sends the actions and any results to the trusted device.

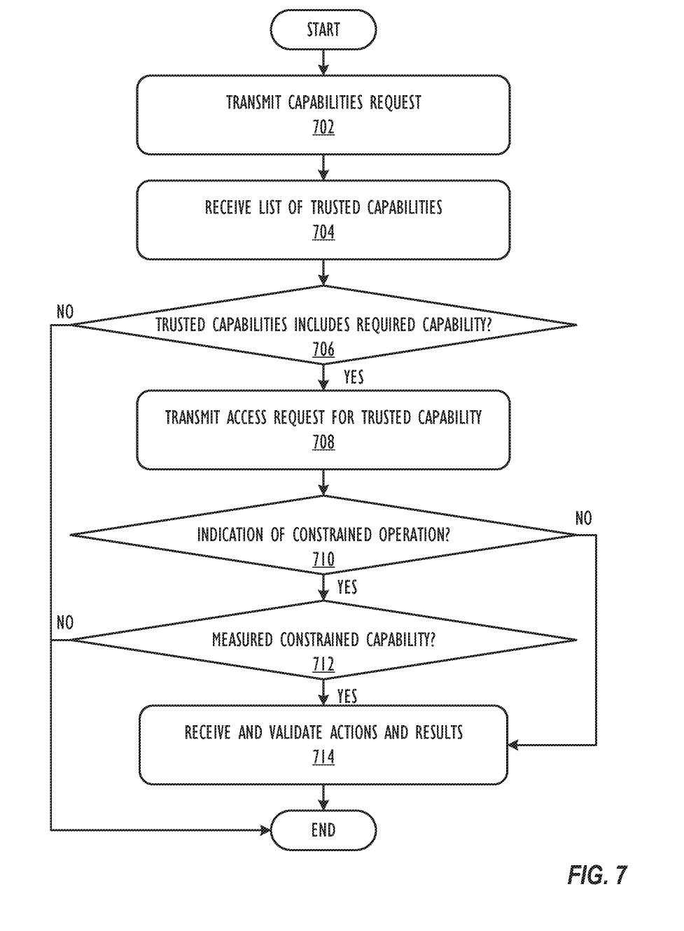

FIG. 7 is a flowchart illustrating a technique for establishing a trusted remote connection, in accordance with aspects of the present disclosure. In block 702, a trusted device, such as trusted device 502, transmits a capabilities request to a remote surface, such as remote surfaces 506A, 506B and 506C, in a manner similar to that described for block 602.

In block 704, the trusted device receives a list of trusted capabilities from the remote surface in response to the capabilities request and in block 706, determines whether the list of trusted capabilities includes any required or minimum set of required capabilities by the trusted device. Where the trusted capabilities of the remote surface do not satisfy the required capabilities by the trusted device, execution may end. In some embodiments, a capability negotiation may also be performed.

If the required capabilities are available, in block 708, an access request is transmitted to the remote surface. This access request may be processed by the remote surface as described in conjunction with block 610.

In block 710, if an indication of a constrained operation is received from the remote surface, for example a request to perform a re-attestation process, the trusted device may measure a capability associated with the constrained operation in performing the re-attestation in block 712. If the measurement of the constrained capability does not succeed, execution ends. Otherwise the trusted device may indicate to the remote surface a successful attestation.

If an indication of a constrained operation is not received in block 710, or if re-attestation is successful in block 712, in block 714, the trusted device receives actions and results of the workload from the trusted device. The trusted device may validate the received actions and results to ensure that the actions and results are within expected boundaries and act upon the received actions and results. For example, where the returned actions and results are associated with a workload for selecting a configuration option from a set of options, the trusted device may verify that the resulting selected configuration option is from the set of options and/or that the selected configuration option can actually be implemented. After validation, the trusted device may then implement the selected configuration option.

According to aspects of the present disclosure, a trusted remote connection may be established between multiple devices as a part of a connection establishment procedure. A remote connection may also be established after a prior connection is established. For example, two or more devices may be connected via an established, untrusted connection. A user may then attempt to perform an operation that requires a trusted connection. The devices may then establish a trusted connection as described above to perform the operation.

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “a computer system” can refer to a single computer or a plurality of computers working together to perform the function described as being performed on or by a computer system.

Example 1 is a machine-readable medium, on which are stored instructions, comprising instructions that when executed cause a target device to: receive, from a connecting device, a capabilities request; measure, in response to the capabilities request, trusted capabilities of the target device; generate a list of trusted capabilities; transmit, to the connecting device, the list of trusted capabilities; receive, from the connecting device, an access request for a trusted capability, the access request comprising a workload for the trusted capability; perform the workload to obtain a result; and transmit, to the connecting device, the obtained result.

In Example 2 the subject matter of Example 1 optionally includes wherein the capabilities request is included in a remote attestation request and the measuring is performed as a part of performing a remote attestation protocol.

In Example 3 the subject matter of any of Examples 1-2 optionally includes wherein the access request includes an indication of constrained operations for execution by the target device with enhanced security.

In Example 4 the subject matter of Example 3 optionally includes wherein the instructions that when executed further cause the target device to: receive an input requesting execution of a constrained operation from a list of constrained operations; perform another measurement of software or hardware components associated with the constrained operation; and execute the constrained operation if the another measurement is successful.

In Example 5 the subject matter of any of Examples 1-2 optionally includes wherein the list of trusted capabilities comprise a list of capabilities the target device may execute within a trusted execution environment (TEE).

In Example 6 the subject matter of Example 5 optionally includes wherein the workload comprises code associated with the trusted capability for execution by the target device, and wherein the instructions that when executed further cause the target device to: execute the workload within the TEE; and transmit a response to the connecting device, the response having an indication of the workload executed and results of the workload execution.

Example 7 is a machine-readable medium, on which are stored instructions, comprising instructions that when executed cause a connecting device to: transmit, to a target device, a capabilities request; receive, in response to the capabilities request, a list of trusted capabilities; determine the list of trusted capabilities includes one or more required capabilities; and transmit, to the target device, a request for access to a trusted capability.

In Example 8 the subject matter of Example 7 optionally includes wherein the capabilities request is included in a remote attestation request.

In Example 9 the subject matter of any of Examples 7-8 optionally includes wherein the request for access includes an indication of constrained operations for execution by the target device with enhanced security.

In Example 10 the subject matter of Example 9 optionally includes wherein the indication of constrained operations comprises a list of constrained operations and wherein the instructions that when executed further cause the target device to: receive, from the target device, an indication that execution of a constrained operation, from the list of constrained operations, is requested; and perform another measurement of software or hardware components associated with the constrained operation.

In Example 11 the subject matter of any of Examples 7-8 optionally includes wherein the list of trusted capabilities comprise a list of capabilities the target device may execute within a trusted execution environment (TEE).

In Example 12 the subject matter of Example 7 optionally includes wherein the access request includes a workload, the workload comprising code associated with the trusted capability for execution by the target device, and wherein the instructions further comprise instructions that when executed cause the connecting device to: receive a response from the target device, the response having an indication of the workload executed and results of executing the workload; and take one or more actions based on the results.

Example 13 is an apparatus for performing trusted operations, comprising: a memory storing instructions for performing trusted operations; and a processor operatively coupled to the memory and adapted to execute the instructions stored in the memory to cause the processor to: receive, as a target device, a message from a connecting device, the message requesting trusted capabilities of the target device; exchange attestation information with the connecting device; obtain a list of trusted capabilities; receive, from the connecting device, an access request for a trusted capability of the list of trusted capabilities, the access request comprising a workload for the trusted capability; perform the workload to obtain a result; and transmit, to the connecting device, the obtained result.

In Example 14 the subject matter of Example 13 optionally includes wherein the access request is received as a part of the exchanged attestation information.

In Example 15 the subject matter of any of Examples 13-14 optionally includes wherein the access request includes an indication of constrained operations for execution by the target device with enhanced security.

In Example 16 the subject matter of Example 15 optionally includes further comprising instructions to cause the processor to: receive an input requesting execution of a constrained operation from a list of constrained operations; exchange another attestation information related to software or hardware components associated with the constrained operation; and execute the constrained operation if the other attestation information attests to the software or hardware components.

In Example 17 the subject matter of any of Examples 13-14 optionally includes wherein the list of trusted capabilities comprises a list of capabilities the target device may execute within a trusted execution environment (TEE).

In Example 18 the subject matter of Example 17 optionally includes wherein the workload comprises code associated with the trusted capability for execution by the target device further comprising instructions to cause the processor to: execute the workload within the TEE; and transmit a response to the connecting device, the response having an indication of the workload executed and results of the workload execution.

Example 19 is a method for performing trusted operations, comprising: transmitting, to a target device, a capabilities request; exchanging attestation information with the target device; receiving, a list of trusted capabilities; determining the list of trusted capabilities includes one or more required capabilities; and transmitting, to the target device, a request for access to a trusted capability.

In Example 20 the subject matter of Example 19 optionally includes wherein the capabilities request is included in the exchanging attestation information.

In Example 21 the subject matter of any of Examples 19-20 optionally includes wherein the request for access includes an indication of constrained operations for execution by the target device with enhanced security.

22. The method of Example 21 optionally includes wherein the indication of constrained operations comprises a list of constrained operations and further comprising: receiving, from the target device, an indication that execution of a constrained operation, from the list of constrained operations, is requested; and exchanging another attestation information related to software or hardware components associated with the constrained operation.

In Example 23 the subject matter of Example 19 optionally includes wherein the list of trusted capabilities comprise a listing of capabilities the target device may execute within a trusted execution environment (TEE).

In Example 24 the subject matter of any of Examples 19-20 optionally includes wherein the access request includes a workload, the workload comprising code associated with the trusted capability for execution by the target device, and further comprising: receiving a response from the target device, the response having an indication of the workload executed and results of executing the workload; and taking one or more actions based on the results.

Example 25 is an apparatus for performing trusted operations as a target device, comprising: means for receiving, from a connecting device, a capabilities request; means for measuring, in response to the capabilities request, trusted capabilities of the target device; means for generating a list of trusted capabilities; means for transmitting, to the connecting device, the list of trusted capabilities; means for receiving, from the connecting device, an access request for a trusted capability, the access request comprising a workload for the trusted capability; means for performing the workload to obtain a result; and means for transmitting, to the connecting device, the obtained result.

In Example 26 the subject matter of Example 25 optionally includes wherein the capabilities request is included in a remote attestation request and the means for measuring performs the measuring as a part of performing a remote attestation protocol.

In Example 27 the subject matter of Example 27 optionally includes further comprising: means for receiving an input requesting execution of a constrained operation from a list of constrained operations; means for performing another measurement of software or hardware components associated with the constrained operation; and means for executing the constrained operation if the another measurement is successful.

In Example 29 the subject matter of any of Examples 25-26 optionally includes wherein the list of trusted capabilities comprise a list of capabilities the target device may execute within a trusted execution environment (TEE).

In Example 30 the subject matter of Example 29 optionally includes wherein the workload is associated with the trusted capability for execution by the target device, and the apparatus further comprises: means for executing the workload within the TEE; and means for transmitting a response to the connecting device, the response having an indication of the workload executed and results of the workload execution.

Example 31 is an apparatus for performing trusted operations by a connection device, comprising: means for transmitting, to a target device, a capabilities request; means for receiving, in response to the capabilities request, a list of trusted capabilities; means for determining the list of trusted capabilities includes one or more required capabilities; and means for transmitting, to the target device, a request for access to a trusted capability.

In Example 32 the subject matter of Example 31 optionally includes wherein the capabilities request is included in a remote attestation request.

In Example 33 the subject matter of any of Examples 31-32 optionally includes wherein the request for access includes an indication of constrained operations for execution by the target device with enhanced security.

In Example 34 the subject matter of Example 33 optionally includes wherein the indication of constrained operations comprises a list of constrained operations and the apparatus further comprises: means for receiving, from the target device, an indication that execution of a constrained operation, from the list of constrained operations, is requested; and means for performing another measurement of software or hardware components associated with the constrained operation.

In Example 35 the subject matter of any of Examples 31-32 optionally includes wherein the list of trusted capabilities comprise a list of capabilities the target device may execute within a trusted execution environment (TEE).

In Example 36 the subject matter of Example 31 optionally includes wherein the access request includes a workload, the workload is associated with the trusted capability for execution by the target device, and the apparatus further comprises: means for receiving a response from the target device, the response having an indication of the workload executed and results of executing the workload; and means for taking one or more actions based on the results.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

We claim:

1. A machine-readable medium, on which are stored instructions, comprising instructions that when executed cause a target device to:
receive, from a connecting device, a capabilities request;
measure, in response to the capabilities request, trusted capabilities of the target device;
generate a list of trusted capabilities;
transmit, to the connecting device, the list of trusted capabilities;
receive, from the connecting device, an access request for a trusted capability, the access request comprising a workload for the trusted capability;
perform the workload to obtain a result; and
transmit, to the connecting device, the obtained result.

2. The machine-readable medium of claim 1, wherein the capabilities request is included in a remote attestation request and the measuring is performed as a part of performing a remote attestation protocol.

3. The machine-readable medium of claim 1, wherein the access request includes an indication of constrained operations for execution by the target device with enhanced security.

4. The machine-readable medium of claim 3, wherein the instructions that when executed further cause the target device to:
receive an input requesting execution of a constrained operation from a list of constrained operations;
perform another measurement of software or hardware components associated with the constrained operation; and
execute the constrained operation if the another measurement is successful.

5. The machine-readable medium of claim 1, wherein the list of trusted capabilities comprise a list of capabilities the target device may execute within a trusted execution environment (TEE).

6. The machine-readable medium of claim 5, wherein the workload comprises code associated with the trusted capability for execution by the target device, and wherein the instructions that when executed further cause the target device to:
execute the workload within the TEE; and
transmit a response to the connecting device, the response having an indication of the workload executed and results of the workload execution.

7. A machine-readable medium, on which are stored instructions, comprising instructions that when executed cause a connecting device to:
transmit, to a target device, a capabilities request;
receive, in response to the capabilities request, a list of trusted capabilities;
determine the list of trusted capabilities includes one or more required capabilities; and
transmit, to the target device, a request for access to a trusted capability.

8. The machine-readable medium of claim 7, wherein the capabilities request is included in a remote attestation request.

9. The machine-readable medium of claim 7, wherein the request for access includes an indication of constrained operations for execution by the target device with enhanced security.

10. The machine-readable medium of claim 9, wherein the indication of constrained operations comprises a list of constrained operations and wherein the instructions that when executed further cause the target device to:
receive, from the target device, an indication that execution of a constrained operation, from the list of constrained operations, is requested; and
perform another measurement of software or hardware components associated with the constrained operation.

11. The machine-readable medium of claim 7, wherein the list of trusted capabilities comprise a list of capabilities the target device may execute within a trusted execution environment (TEE).

12. The machine-readable medium of claim 7, wherein the access request includes a workload, the workload comprising code associated with the trusted capability for execution by the target device, and wherein the instructions further comprise instructions that when executed cause the connecting device to:
receive a response from the target device, the response having an indication of the workload executed and results of executing the workload; and
take one or more actions based on the results.

13. An apparatus for performing trusted operations, comprising:
a memory storing instructions for performing trusted operations; and
a processor operatively coupled to the memory and adapted to execute the instructions stored in the memory to cause the processor to:
receive, as a target device, a message from a connecting device, the message requesting trusted capabilities of the target device;
exchange attestation information with the connecting device;
obtain a list of trusted capabilities;
receive, from the connecting device, an access request for a trusted capability of the list of trusted capabilities, the access request comprising a workload for the trusted capability;
perform the workload to obtain a result; and
transmit, to the connecting device, the obtained result.

14. The apparatus of claim 13, wherein the access request is received as a part of the exchanged attestation information.

15. The apparatus of any of claim 13, wherein the access request includes an indication of constrained operations for execution by the target device with enhanced security.

16. The apparatus of claim 15, further comprising instructions to cause the processor to:
receive an input requesting execution of a constrained operation from a list of constrained operations;
exchange another attestation information related to software or hardware components associated with the constrained operation; and
execute the constrained operation if the other attestation information attests to the software or hardware components.

17. The apparatus of any of claim 13, wherein the list of trusted capabilities comprises a list of capabilities the target device may execute within a trusted execution environment (TEE).

18. The apparatus of claim 17, wherein the workload comprises code associated with the trusted capability for execution by the target device further comprising instructions to cause the processor to:
execute the workload within the TEE; and
transmit a response to the connecting device, the response having an indication of the workload executed and results of the workload execution.

19. A method for performing trusted operations, comprising:
transmitting, to a target device, a capabilities request;
exchanging attestation information with the target device;
receiving, a list of trusted capabilities;
determining the list of trusted capabilities includes one or more required capabilities; and
transmitting, to the target device, a request for access to a trusted capability.

20. The method of claim 19, wherein the capabilities request is included in the exchanging attestation information.

21. The method of claim 19, wherein the request for access includes an indication of constrained operations for execution by the target device with enhanced security.

22. The method of claim 21, wherein the indication of constrained operations comprises a list of constrained operations and further comprising:
receiving, from the target device, an indication that execution of a constrained operation, from the list of constrained operations, is requested; and
exchanging another attestation information related to software or hardware components associated with the constrained operation.

23. The method of claim 19, wherein the list of trusted capabilities comprise a listing of capabilities the target device may execute within a trusted execution environment (TEE).

24. The method of claim 19, wherein the access request includes a workload, the workload comprising code associated with the trusted capability for execution by the target device, and further comprising:
receiving a response from the target device, the response having an indication of the workload executed and results of executing the workload; and
taking one or more actions based on the results.
